(19) United States
(12) Patent Application Publication
(10) Pub. No.: US 2014/0372896 A1
(43) Pub. Date: Dec. 18, 2014

(54) USER-DEFINED SHORTCUTS FOR ACTIONS ABOVE THE LOCK SCREEN

(71) Applicant: Microsoft Corporation, Redmond, WA (US)

(72) Inventor: Sunder Nelatur Raman, Redmond, WA (US)

(21) Appl. No.: 13/918,720

(22) Filed: Jun. 14, 2013

(51) Int. Cl. G06F 3/0488; G06F 3/0481

(52) U.S. Cl. CPC G06F 3/0488; G06F 3/04817
USPC 715/741

(57) ABSTRACT

Customized tasks can be performed above the lock screen in response to a user-defined shortcut input as an interaction with a user interface of a device while the device is in a locked state. A method for facilitating user-defined shortcuts for actions above the lock screen includes at least monitoring user interactions made with respect to the user interface of the device while the device is in the locked state for at least one interaction associated with at least one feature of an application. The user interaction may be a gestural input of a custom combination of one or more gestures on a designated region of the lock screen. The user-defined shortcut may be reconfigured at any time by a user.

### BACKGROUND

A lock screen refers to a display or privacy screen of a user interface that regulates access to a device (and underlying content) when active. Typically, a lock screen is employed in order to prevent unintentional execution of processes or applications. A user may lock their computing device or the device may lock itself after a period of inactivity, after which the lock screen may be displayed when the device is woken up. A lock screen is generally a function of an operating system and is used to limit the interaction with a computing device, including executing applications and accessing data below the screen. To return to full interaction, a user can perform certain actions, including password entry or a click or gesture, to unlock the computing device via the lock screen.

In some cases, the lock screen may present limited information and even shortcuts to applications below the screen. To address recurrent and time sensitive tasks, sonic functionality and content is slowly emerging for access above the lock screen. This extended functionality can minimize the hindrance of unlocking a computing device and locating and launching an application to invoke functionality. As one example, an incoming text message may be displayed above the lock screen. As another example, access to a camera on a smart phone or tablet can be accomplished above the lock screen in a manner that provides timely access at a moment of need as well as maintaining privacy of the information (and photographs) below the screen. Available tasks that can be accessed and executed above the lock screen are built in or dependent on the operating system.

### BRIEF SUMMARY

Systems are presented in which above the lock screen task functionality is extended beyond those made available by the underlying operating system of a device to user-defined shortcuts that invoke custom tasks above the lock screen.

In particular, user interactions with a device while the device is in a lock mode can be monitored and, in response to an occurrence of an interaction defined by the user for association with a feature of an application available on the device, the application feature to enable the application to carry out above the lock screen functionality may be invoked.

The interaction may be a gesture (spatial or touch), voice, or movement of the device, or incorporate any sensor included on the device (e.g., accelerometer, gyroscope, infrared sensor). The system can monitor the user interaction(s) for an occurrence of the defined interaction. In some cases, where the monitored user interactions are touch-based, input from a specific region of the screen can be monitored for an occurrence of the defined interaction.

According to certain implementations, a user can configure interactions for association with specific features and tasks of an application. Implementations enable applications to be accessible above the lock screen without a specific icon. In addition to enabling a user to define the input that creates the shortcut to a particular application or task, a user may specify custom tasks that an application chooses to provide to the user to customize for association with the shortcut.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a system that facilitates user-defined shortcuts above a lock screen.

FIG. 2 illustrates an implementation of a system that facilitates user-defined shortcuts above a lock screen.

FIGS. 3A and 3B illustrate example process flows for facilitating user-defined shortcuts for actions above the lock screen.

FIG. 4 is an example screenshot of a region receptive to a user-defined shortcut having separate regions for specified inputs to non-customized tasks.

FIG. 5 is an example screenshot of a region receptive to a user-defined shortcut having an overlapping region for a specified input to a non-customized task.

FIGS. 6A-6C are example screen shots illustrating configuration of a shortcut.

FIG. 7 shows a simplified process flow of a lock screen configured to receive user-defined shortcuts.

FIGS. 8A-8E are example screen shots illustrating a user-defined shortcut deployment of a task.

FIG. 9 is a block diagram illustrating components of a computing device used in some embodiments.

FIG. 10 illustrates an architecture for a computing device on which embodiments may be carried out.

### DETAILED DESCRIPTION

Details below are generally directed toward customized shortcuts facilitating access of an extended lock screen experience.

As used herein, “above the lock screen” or “above a lock screen” refers to actions performed while a computing device is in a locked state, and “below the lock screen” or “below a lock screen” is intended to refer to actions performed when a computing device is in an unlocked state. The actions performed above or below the lock screen include, but are not limited to, initiating execution of computer executable code and input and output of data,

In many devices, actions above the lock screen are limited to those needed to transition to an unlocked state where most actions are performed. In some cases where a. gesture or other input is entered above the lock screen to change the state of the device (from locked to unlocked or from locked to a functional state while the device remains in a lock state), the deployment of those actions are a result of a particular gesture or shortcut specified by the operating system. In particular, hard coded (as part of the operating system or application-defined) input features, such as a “slide to unlock”, camera access, or an icon shortcut to an application may be rendered above the lock screen.

As described herein, above the lock screen functionality is made available to user-defined shortcuts. A developer of an application may enable tasks that can be run in an above the lock screen mode and a user may select to access such tasks from above the lock screen as well as define a particular shortcut to a selected task. When a user invokes a task through the user-defined. shortcut, the task is executed while the device remains in the locked state. In some cases, a portion of the application may be deployed to run above the lock screen. In some cases, an application may be deployed in full.

A shortcut component can provide an intermediary between user input while the device is in a locked state and an application having actions that could be performed above the lock screen. User-defined shortcuts minimize the space needed to access programs because shortcuts for the applications do not reside or need to be rendered on the lock screen. Any application that has some above the-lock screen functionality may provide that functionality to a user through a user-defined shortcut as described herein. Existing and future developed (including third party) above the lock screen functions may be invoked through user-defined interactions.

In addition, a user may select or customize the particular task to which the custom gesture is associated with.

Instead of multiple icons or other indicators of a shortcut available to a user, the user input is the shortcut. According to certain embodiments, the user is not provided with a display of icons or other graphics indicating available tasks or application features. Instead, a user defines a shortcut with a custom user-defined interaction with the device. Then, in some cases where the user-defined shortcut deploys a full application (or a portion designed for above the lock screen mode), the deployed application can include icons and interfaces above the lock screen for interaction by the user (and invocation of additional tasks).

A user may define shortcuts that enable the user to, for example, dial a phone number by tracing the letter “C”, text a custom message of “I′m busy, I′ll get back to you ASAP” to a phone number by tracing the letter “W”, play a favorite song by tracing a spiral, get a weather report by drawing a sun with a circle and rays, and make a grocery list in a note by tracing the letter “O” as just a few examples of quick tasks that may be accomplished. Furthermore, the user may decide to change the shortcut, for example by changing the text message shortcut to a star shape instead of a previously defined “W”.

To facilitate user-defined shortcuts, user interactions with a user interface are monitored and in response to receiving a previously defined interaction, the application associated with the task is called so that the application can be notified that a command for a particular task has been received and the application can execute the task while the device is in the locked state.

The user-defined shortcuts can be gestural (touch or motion-based) or be implemented using input to one or more other sensing or input devices of a computing device, for example, using an accelerometer or gyroscope or microphone. A user-defined gesture can include symbols, characters, tap(s), tap and hold, circle, multi-touch (e.g., two or more fingers contacting the touch screen at a same time), single-touch, and pressing a physical or virtual button. Alternative custom inputs may be available including those based on audio and motion (e.g., through accelerometer or gyroscope sensing). Other gestures and input may be used so long as the system can recognize the input and have that input associated with executing a command to invoke a task.

According to various implementations, an input device of a computing device is monitored for receipt of a user-defined interaction with the computing device. As input signals are received from the input device, the signals are compared with the user-defined interaction data stored in the device. It should be understood that a user may select what input devices may be monitored for user interactions while the device is in the locked state (and even otherwise).

Various aspects of the subject disclosure are now described in more detail with reference to the drawings. It should be understood that the drawings and detailed description relating thereto are not intended to limit the claimed subject matter to the particular form disclosed. Rather, the intention is to cover all modifications, equivalents, and alternatives falling within the spirit and scope of the claimed subject matter.

Specific examples are shown with respect to user-defined gestures to implement a shortcut; however, it should be understood that these examples a merely demonstrative and are not intended to limit the types interactions that may be defined by a user for a specified task.

A computing device, such as a mobile phone, tablet, laptop, and the like, or a stationary desktop computer, terminal and the like, can begin in a sleep, or locked, state. Devices like smartphones, laptops, tablets, and slates provide a lock screen on wake. Lock screens may provide varying degrees of information as content is permitted to be surfaced in the lock screen interface, for example notifications sent by an incoming text message from a SMS or MMS client or an alert of an upcoming meeting from and email and scheduling client. Lock screens may also provide varying degrees of utility, for example the ability to launch a camera, unlock via a picture password, and select lock screen widgets. The content and the utilities surfaced in the lock screen interface are made available to the user before unlocking the device.

In response to a first interaction, for example a swipe gesture, received from a first interaction region of the lock screen, the mobile phone can transition from the locked state to a phone state, for example corresponding to a main screen (e.g., home screen, idle screen) below the lock screen, allowing conventional interaction. In response to a second interaction received from a second interaction region of the lock screen, a predefined task is invoked while remaining in a locked state. In some cases, the predefined task deploys application features above the lock screen for a user to interact with. In some cases, the predefined task is performed in response to the second interaction with no additional input from the user taking place. For example, an interaction invoking a message with prewritten content to be sent by an email client while the mobile phone is in the locked state.

In addition, it should be appreciated that a plurality of different gestures can be employed, such as, but not limited to, gesturing different locations within the second interaction region, tapping different locations within the second interaction region, moving content (e.g., drag application icon to lock icon to unlock or moving lock icon to application icon to unlock or moving brush icon to draw a gesture the user associates with invoking a predefined task), specific gesture patterns (e.g., horizontal swipe, vertical swipe, horizontal swipe followed by a downward vertical swipe, tracing a letter), ending gestures on different locations. Other interaction regions may be available, for example employing moving covers (e.g., gesture from first corner to another corner in a diagonal swipe, where the first corner is an application icon), or sliding windows (e.g., swipe motion up, swipe motion down, swipe motion right, swipe motion left, where start of swipe is a smaller window for an application icon). In general, it is to be appreciated and understood that the subject innovation includes any suitable gesture input from a lock screen state.

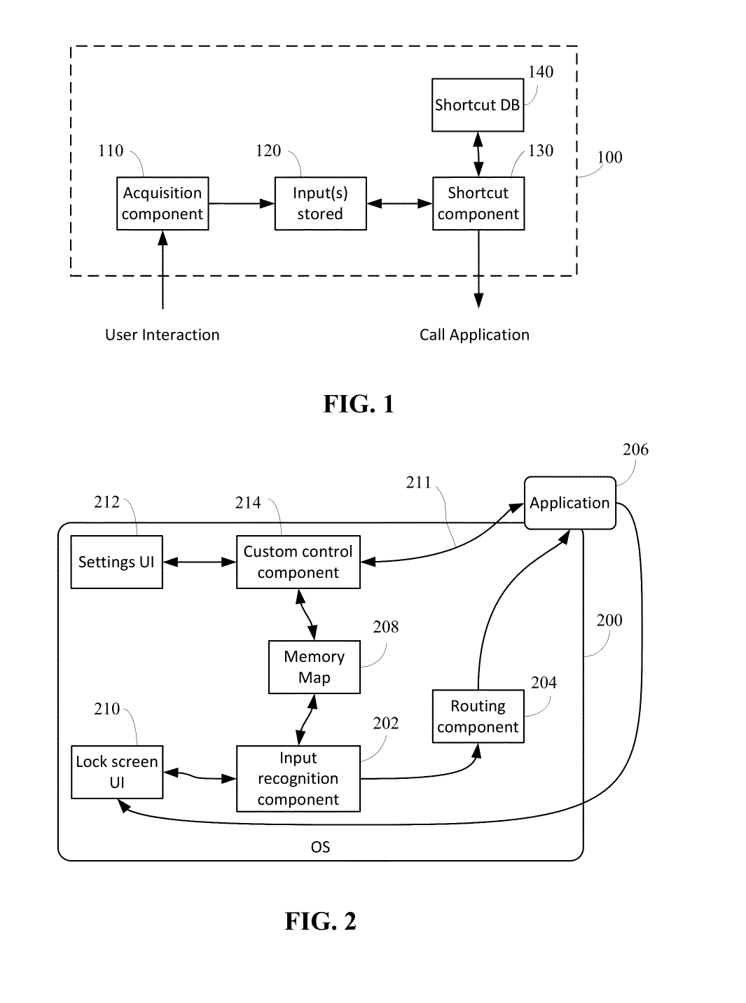

Referring to FIG. 1, a user-defined shortcut system 100 is illustrated that facilitates the execution of an action to be carried out while a device is in a locked state in response to a user-defined shortcut executed above a lock screen. That is, a shortcut deployment of customized tasks embodied as a user-defined input can be performed above the lock screen.

The user-defined shortcut system 100 can be used to invoke a task in response to a user interaction with the lock screen where the user interaction is a previously user-defined interaction for a task to perform that task.

The particular applications, actions, or tasks that are enabled to be deployed above the lock screen through the system illustrated in FIG. 1 are not limited. Should an application indicate that there is a feature that is permitted to be deployed above the lock screen (which may be the entire application or portions thereof), then a shortcut to such an application may be permitted to be created.

The user-defined shortcut system 100 may include an acquisition component 110 configured to receive, retrieve, or otherwise obtain or acquire user interactions represented by input data 120. The input data 120 may be stored for a time sufficient to determine whether an input matches a user interaction indicative of a shortcut.

One or more applications (e.g., sets of structions, program modules, data, updates, and the like specified in a computer programming language that when executed by a computer performs the functionality described by such elements) may provide functionality that can be deployed above the lock screen,

The user-defined shortcut system 100 may include a shortcut component 130 that is configured to call an application (or a portion of an application designated to provide a particular function) that is mapped to a recognized user interaction. The shortcut component 130 can determine whether the input data received as part of a user interaction matches a predefined shortcut in a shortcut database 140. In some cases, the input data is directly provided to the application to which the user-defined interaction is mapped. In some cases, processing on the data is carried out by the shortcut component to place the data in a form that the application understands.

The shortcut database 140 can include the appropriate mapping for a user-defined shortcut and its corresponding application or task. In some cases, the shortcut database may include a look-up table or some other approach to enable the shortcut component to match an input to its associated task.

Once the appropriate application is called, the application can carry out its tasks.

It is to be appreciated that the user-defined shortcut system 100 can be employed with any “computer” or “computing device,” defined herein to include a mobile device, handset, mobile phone, laptop, portable gaming device, tablet, smart phone, portable digital assistant (PDA), gaming console, web browsing device, portable media device, portable global positioning assistant (GPS) devices, electronic reader devices (e.g., e-readers), touch screen televisions, touch screen displays, tablet phones, any computing device that includes a lock screen, and the like.

FIG. 2 illustrates an implementation of a system that facilitates user-defined shortcuts above a lock screen. Aspects of the user-defined shortcut system of FIG. 1 may be carried out by an operating system 200.

For the description of the implementation illustrated in FIG. 2, a gesture input is described as the user-defined shortcut; however it should be understood that other types of inputs can be used with similar architectures. As discussed, a gesture input (or other user input) may be used as a user-defined shortcut for a task, both the shortcut and the task being carried out above the lock screen. That is, a custom gesture can be tied to a task that can then be triggered based on the gesture. The acquisition component (e.g., 110 of FIG. 1) may be part of an input recognition component 202. In addition, the shortcut component (e.g., 130 of FIG. 1) may be implemented as part of the input recognition component 202 and the routing component 204. In response to receiving a gesture in a designated area of a lock screen, the operating system 200 can determine whether the gesture is a recognized gesture associated with a particular task. In response to recognizing a gesture, the operating system 200 can trigger the associated task by calling the application 206 handling the task.

As discussed herein, the functionality of a device is extended above the lock screen while maintaining a locked device. In one implementation, pre-selected tasks available through the operating system and even through applications running on the operating system can be invoked above the lock screen through user-defined gestures.

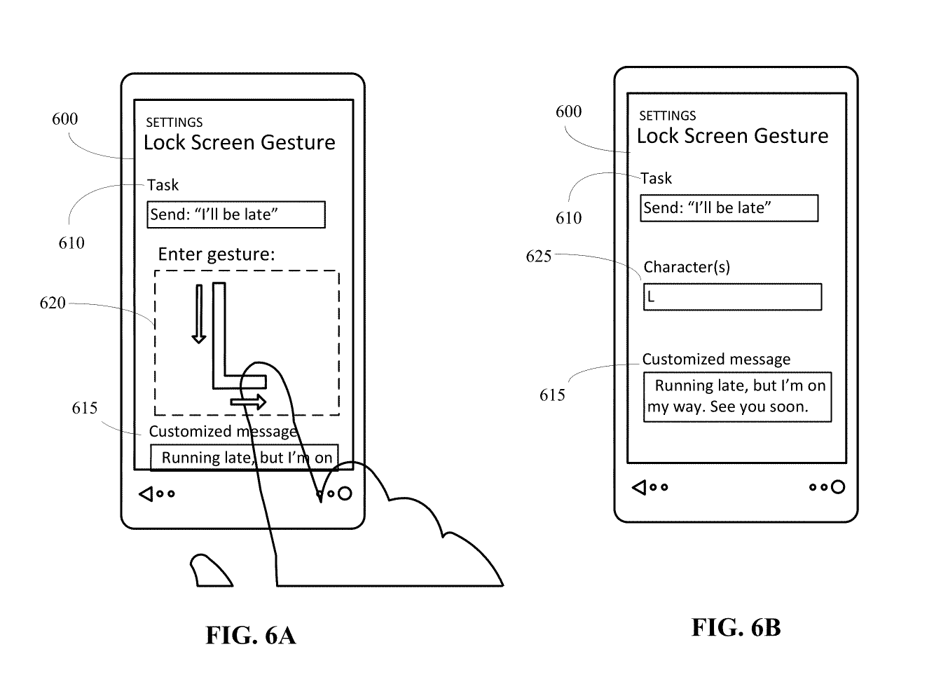

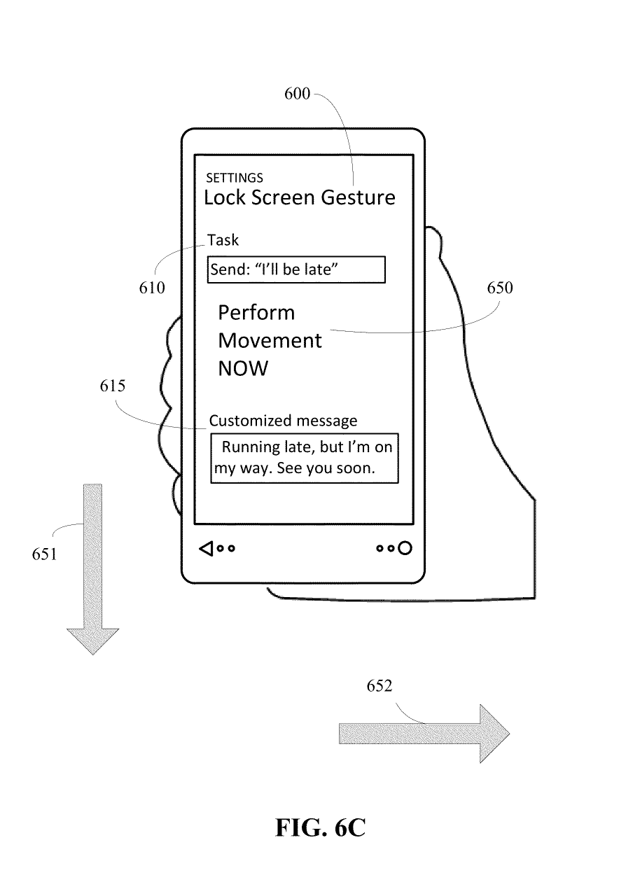

The lock screen presented by the operating system 200 includes an ability to sense gestures (for example via input recognition component 202) and then call (for example via routing component 204) an application 206 that maps to the gesture (as indicated by the memory map 208) to perform an action based on input received from above the lock screen (for example via lock screen user interface (UI) 210). This feature addresses a desire to perform quick tasks, such as reminders and notes. A settings UI 212 may be rendered in order to configure via a custom control component 214 the gestures and associate a gesture with a particular action or task to be carried out by the application 206. Non-limiting example settings UI are shown in FIGS. 6A-6C.

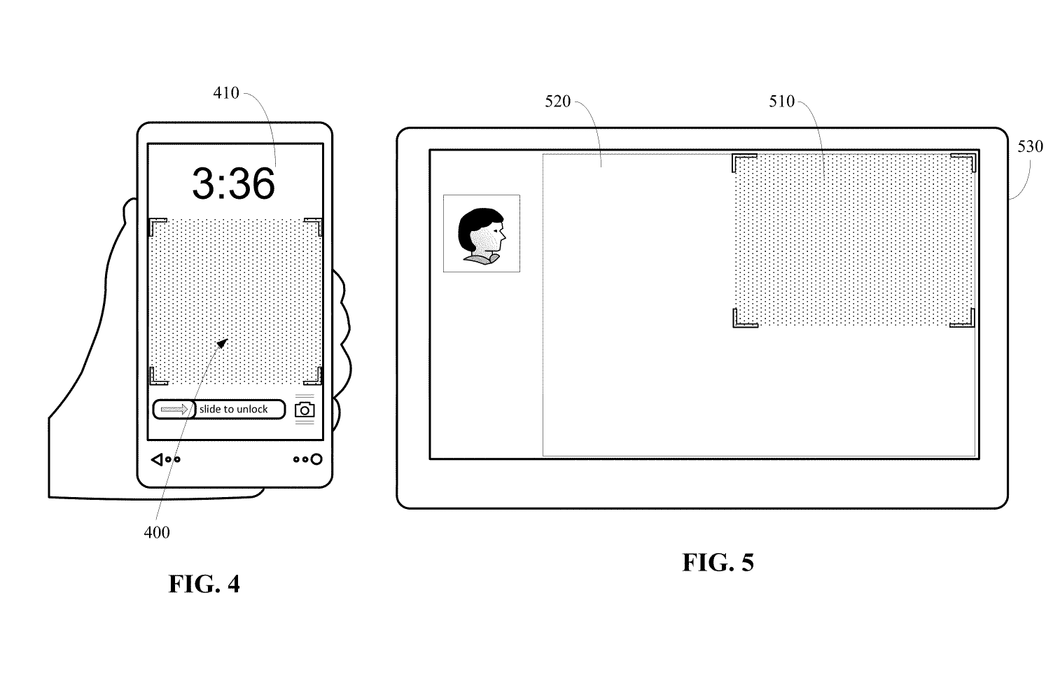

A state is built into the lock screen UI 210 that supports entry of user-defined gestures while above the lock screen (examples shown in FIGS. 4, 5, and 8B). This state, or region, can receive input and the shortcut system can recognize a gesture being performed. For example, an input recognition component 202 may be used. Receipt of a gesture can result in an action being taken. Once the gesture is received and the system recognizes that a task is being invoked, the shortcut system routes, for example via routing component 204, the input into the application associated with the gesture and task. The routing component 204 can communicate with the application 206 to indicate that a task has been invoked. The invocation can include an indication as to the task specified as corresponding to the gesture. The application 206 to which the operating system routes the gesture invocation to can be associated with the operating system (built-in functionality), a browser, email client, or other closely associated application, or a third party application.

To facilitate custom tasks with user-defined shortcuts, an application programming interface (API) can expose that above the screen mode is available (e.g., via 211). For example, a request (e.g., by custom control component 214) to the application 206 may be made to determine whether this application supports above the lock screen mode. If the application 206 responds that it supports above the lock screen mode, then the user can configure a customized input for invoking a designated task for the application (e.g., supported by the custom control component 214). A settings UI 212 can be presented to enable a user to configure a shortcut for a test made available by an application. The custom user control component 214 can assign the user-defined interaction to invoke the application for performing the task. Thus, when an input recognition component 202 receives a gesture recognized as the user-defined interaction, the input recognition component 202 can determine the application to which the gesture is intended to call via the memory map 208 and route the request to the application 206 via the routing component 204.

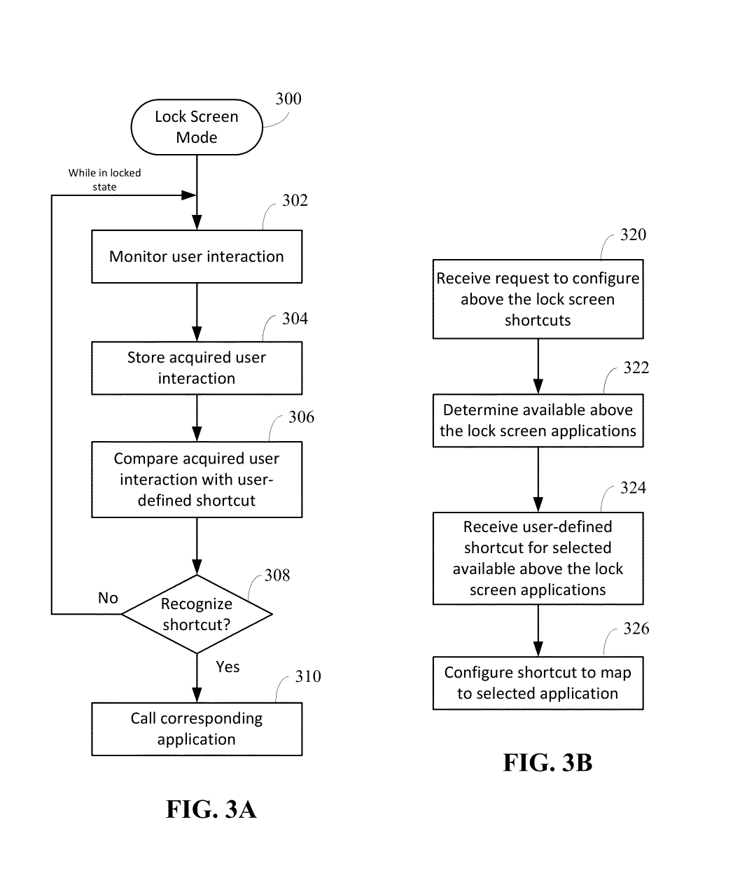

FIGS. 3A and 3B illustrate example process flows for facilitating user-defined shortcuts for actions above the lock screen. Referring to FIG. 3A, while in a locked state (lock screen mode 300), the system may monitor user interaction (302) and store the acquired user interaction (304). The acquired user interaction data may be analyzed to determine if the user interaction matches an interaction representing a shortcut to a task. For example, the acquired user interaction data may be compared with user-defined shortcut data (306) in order to determine if the acquired user interaction is a recognized shortcut (308). Monitoring may continue until a shortcut is recognized or the device is no longer in a locked state. In response to recognizing a shortcut, the corresponding application can be called (310).

FIG. 3B illustrates an example process flow for obtaining the user-defined shortcut data. The system may receive a request to configure above the lock screen shortcuts (320). In response, the available above the lock screen applications are determined (322). This may be carried out by calling the applications available on the system and populating a settings window with the applications that respond indicating that they can provide above the lock screen functionality. A user-defined shortcut may be received for (user) selected ones of the available applications (324). To configure the user-defined shortcuts, the user-defined shortcuts are stored mapped to the corresponding selected application (326). The stored user-defined shortcuts can be used in operation 306 described with respect to FIG. 3A.

The user-defined shortcuts for actions above the lock screen can be implemented on any computing device in which an operating system presents a lock screen. Gesture-based shortcuts can be implemented on devices having a touch screen, touch pad, or even an IR sensor that detects a gesture on, but not contacting a region of the lock screen. Similar shortcuts can be input via mouse or other input device. Implementations may be embodied on devices including, but not limited to a desktop, laptop, television, slate, tablet, smart phone, personal digital assistant, and electronic whiteboard.

The functions of recognizing a movement or contact with a touchscreen as a gesture and determining or providing the information for another application to determine the task associated with the gesture may be carried out by the operating system of the device. According to an embodiment, a region of the lock screen is defined as accepting gestures above the lock screen. When contact or other action that can be sensed by the device is made with this screen, the operating system may determine that the contact corresponds to a gesture. The operating system (or other program performing these functions) may make the determined gesture available to one or more applications running on the device.

For example, the above the lock screen capabilities can be exposed to applications running on the operating system. An application (including those not built-in to the device operating system) may access this capability by indicating support for above the lock screen tasks and requesting to be invoked when a user-defined gesture is recognized by the operating system. The application does not specify the gesture to invoke certain features of the application. Instead, the application can identify the available tasks and functionalities to be made available above the lock screen and the operating system can assign those tasks and functionalities to a user-defined gesture upon a user selecting to associate the two.

For example, an application may indicate and include support for above lock screen mode by providing a flag in its manifest file that describes what capabilities the application uses and needs access to (e.g. location access and the like). Once an application indicates above the lock screen support to the operating system, the operating system can show the application as a target for configuring one or more tasks.

The screen shots illustrated in FIGS. 4, 5, 6A-6C and 8A-8E are merely exemplary and provided to graphically depict at some embodiments of aspects of the disclosure. Of course, the subject disclosure is not intended to be limited to the location or presentation of graphical elements provided since there are a myriad of other ways to achieve the same or similar result.

The touch screen understands gestural input by the poke, prod, flick, and swipe, and other operating system defined gestures. However these gestures are not generally expected above the lock screen. To facilitate the receipt of gestures as shortcuts above the lock screen, a designated region to provide an input field can be exposed. The designated region is where a user can write, flick or perform some interaction and the shortcut component translates the input from the designated region into a character or series of contacts that maps for a particular task.

Referring to FIG. 4, the input field can be a designated region 400 of the lock screen 410. Recognized gestures may be constrained to the designated region 400. A gesture is recognized when it is tied to a task that a user has customized. Instead of a specific developer generated gesture, users can customize a gesture for a particular task.

Referring to FIG. 5, instead of a separate region for receiving an unlock gesture and the above the lock screen shortcuts, the designated region 510 may be on at least a portion of a region 520 on which a gesture password is received. The designated region 510 and the password region 520 may overlap physically and temporally (i.e., both actively exist at a same time). For example, all or a portion of a lock screen region of a tablet 530 being monitored for an unlocking gesture may be monitored to receive a user-defined gesture for invoking a specified task. The input recognition component can then distinguish between a shortcut and an unlock maneuver so long as the user does not set up both tasks with the same gesture. If a same gesture is input for two tasks (or for a gesture password and a task), the user may be notified of the overlap and requested to enter a different gesture.

FIGS. 6A-6C illustrate example interfaces for configuring user-defined gestures. In some cases, the applications that support an above the screen function can be pre-populated in a settings tool when the operating system calls the applications running on the device and receives an indication from the application(s) that above the lock screen functionality is available. The applications can control the features available above the lock screen and the settings can be used to configure the user-defined input for invoking the task.

As part of a below-the-lock-screen or unlocked state function, a calendar application may include a short cut command or button that a user may select to send an email indicating that they are running late to the meeting. In particular, to use this button, a user would unlock the computing device and open the calendar event to select the button to send the message that they are running late. In a user-defined shortcut system (such as shown in FIGS. 1 and/or 2), where the email and calendaring application can provide above the lock screen functionality, a user may select to create a shortcut for performing the task of sending a message that they are running late.

The scenario reflected in FIGS. 6A-6C involves a task available through a mail and calendar client. The mail and calendar client may allow for a calendar alert and response to be made available above the lock screen. The mail and calendar client can indicate to the custom user control component (e.g., 214) that a task is supported for sending a response to a calendar alert. The task may be an automatic reply of “I′m running late” (or some other pre-prepared response) to attendees or the meeting organizer In the settings UI 600, the available task 610 can be rendered and an input field can be provided to enter the user-defined shortcut. In addition, customizations to the task may be available (and corresponding input field(s) may be used to customize the task, for example by providing a customized message 615 for an “I′m late” message task).

In the example shown in FIGS. 6A, the input field may be a region 620 that supports a gesture entry of a shortcut and a user can enter a gesture of a character through performing the gesture in a region of the screen. In the example shown in FIG. 6B, the input field may be region that can receive a typed character 625, and a user can enter a character for use as a gesture by typing in a character that the gesture is to emulate. For the illustrated example, the user is defining the command to send this response from above the lock screen as a gesture of writing “L”. In a further example, additional functionality for modifying the response may be made available above the lock screen. For example, a user may enter “L” for the “I′m running late” response followed by digits representing time (default in a certain unit), for example “L10” may invoke a response of “I′m running 10 minutes late”. Although a letter is shown in the example, embodiments are not limited thereto.

In the example shown in FIG. 6C, a user can enter a physical gesture in response to the settings UI indicating the movement be performed (650). For example, the user may move the device in an “L” motion with a downward movement 651 followed by a rightward movement 652. Of course, the movement can be arbitrary and does not need to follow a particular design. As an example, a shaking of the device up and down and up again (with or without direction/angle) may be input for the custom gesture.

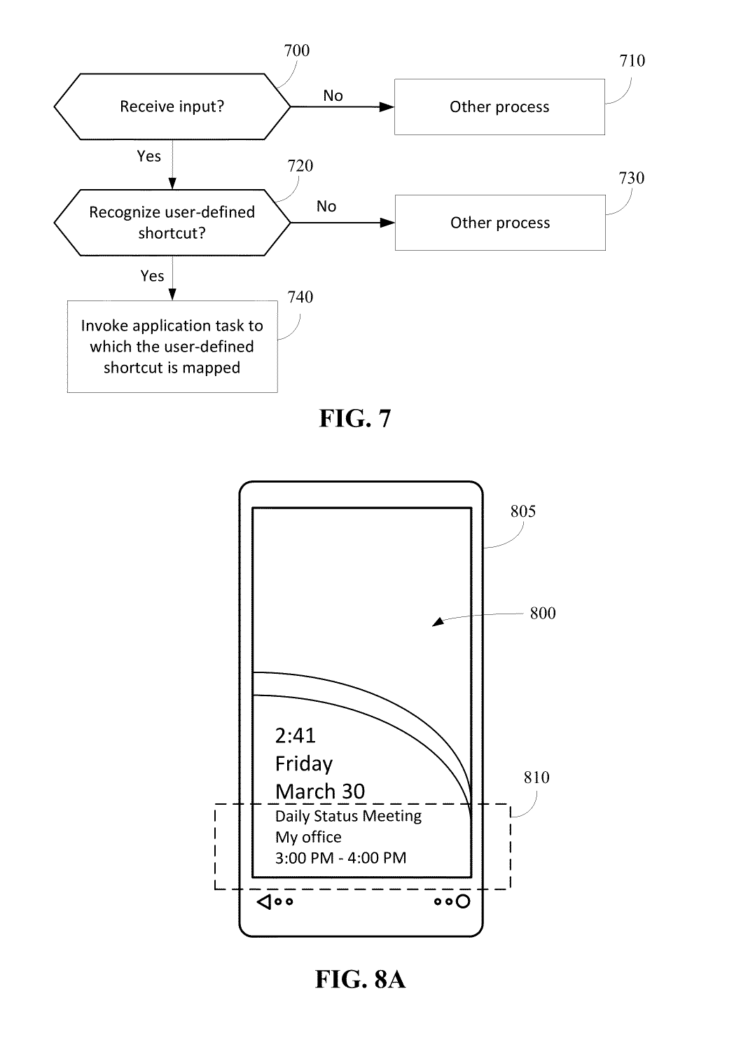

FIG. 7 shows a simplified process flow of a lock screen configured to receive user-defined shortcuts. Referring to FIG. 7, a user interface may be monitored to determine if input is being entered. The monitoring may be continuous, via an interrupt, or another suitable method. If in determining whether input is received (700), if no input is received, other processes may be carried out (710). In some cases if no input is received, the device may remain or enter a sleep state. If input is received, the input is analyzed to determine whether the input is a recognized user-defined shortcut (720). If the input is not a recognized input, then other processes may be carried out (730). The other processes (730) can include an error message. If the input is a recognized input, the application to which the user-defined shortcut is mapped can be invoked (740) to perform the task corresponding to the shortcut.

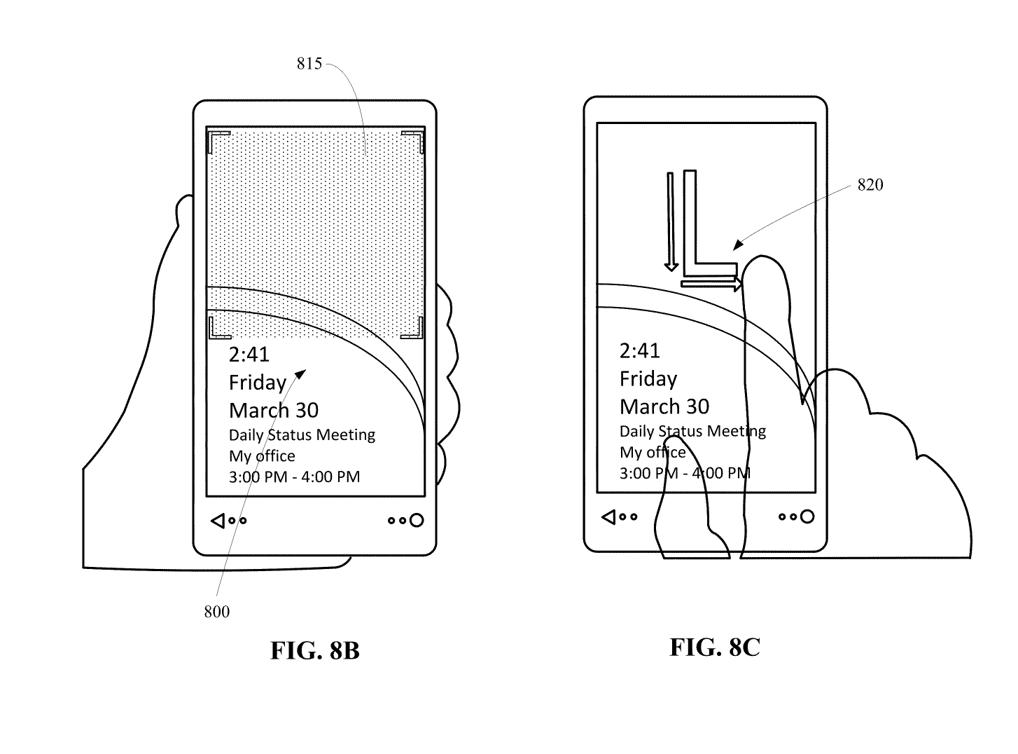

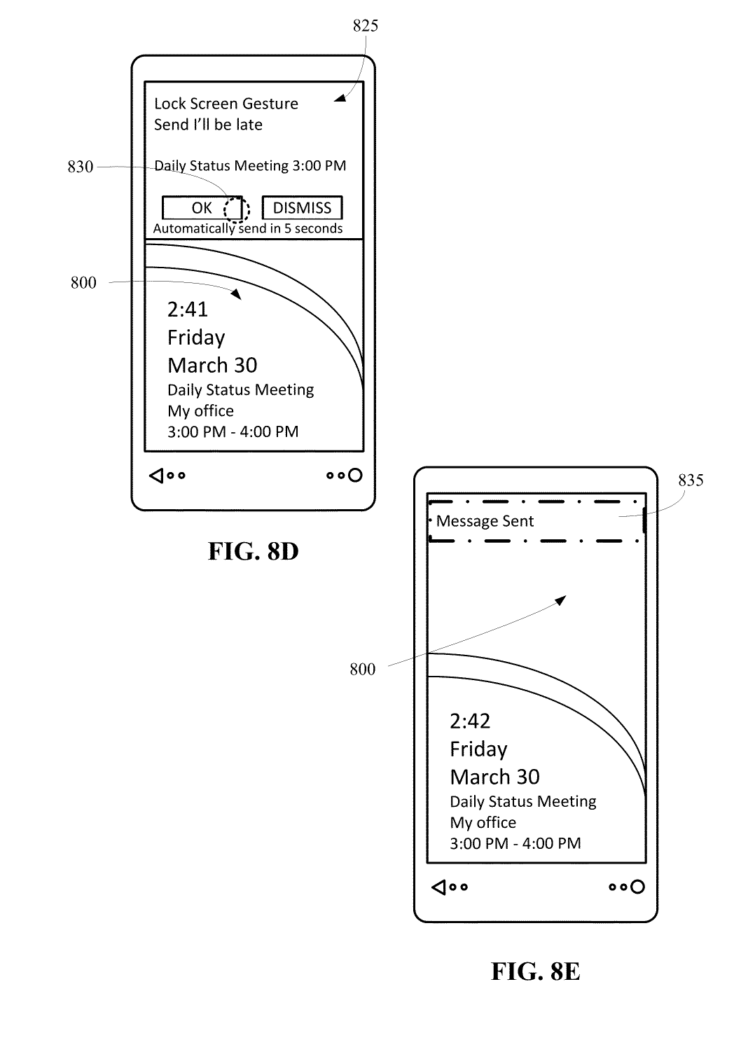

FIGS. 8A-8E are example screen shots illustrating a user-defined shortcut deployment of a task.

Referring to FIG. 8A, by way of example and not limitation, a user may notice that they are running late to a meeting. In one case, the lock screen 800 of a device, such as mobile phone 805, may include a display of calendar content 810 and the user may notice that the event is going to be at a certain time and place. For example, calendar content 810 of a meeting reminder may pop up on the lock screen because the device may be in a “wake” state and display an appointment alert on the lock screen.

A user may be on the lock screen 800 when heading to the meeting even or is in a meeting and is not able (or does not want to) speak or type. A scenario is enabled in which the user can indicate that they will be late to the meeting (or invoke another task) by a shortcut via the lock screen. As shown in FIG. 8B, a designated region 815 is provided for a user to indicate a custom shortcut. A graphic or animation may be present to alert the user that this region is available as an input region. In some cases, the region may not be visually defined or may only become visually defined when the screen is touched.

As illustrated in FIG. 8C, the user may invoke an email and calendar application through a shortcut on the lock screen to perform a previously customized task of sending a late message.

For example, the user may have previously defined a shortcut for a late message as “L” (such as through a settings configuration as illustrated in FIGS. 8A or 8B). Thus, when the user would like to send the “I′m late” message for a meeting event reminder surfaced on the lock screen, the user writes an “L” shape 820 on the designated region of the lock screen. The gesture of the “L” can be a user-customized gesture so that the device knows that when the gesture of the “L” is received above the lock screen, the user is requesting that an “I′m running late for the meeting” message to be sent.

In response to receiving this user-defined shortcut, the associated application is invoked to perform the customized task. Referring to FIG. 8D, a task confirmation window 825 may be rendered in the lock screen 800 from which a user may indicate a command 830 while the device is in the locked state. A screen (or window) may appear on the lock-screen that enables a user to interact with the application while above the lock screen. The particular interactions available to a user can be set by the application. A task completed notification 835 may be rendered on the lock screen 800 to indicate that the task has been accomplished.

Each application can control the tasks supported above the lock screen. For clarity, another quick example is for an application that provides digital filtering of photographs online-photo sharing, such as the INSTAGRAM photo sharing application.

A request to the digital filtering and photo-sharing application may be made to determine whether this application supports above the lock screen mode. If the application responds that it supports above the lock screen mode, then the user can configure a customized input for invoking a designated task for the application, for example, capturing an image and applying a filter from one or more available filters.

The user may decide to configure the short cut as a gesture forming the letter “I”. The custom user control component (e.g., 214) can assign the user-defined gesture of “I” for invoking the application. Thus, when an input recognition component (202) receives a gesture recognized as “I” and mapped to the application, the routing component (204) can invoke the digital filtering and photo-sharing application to perform the designated task of capturing an image and presenting the one or more filters that may be applied to the captured image above the lock screen.

Once invoked by the shortcut, the application may enable taking a picture and applying a filter using a camera API to take a picture and even apply one or more of their filters before saving the filtered picture. However, since the access is above the lock screen, the other pictures in the photo-sharing account for this application may not be accessible and can remain private. Therefore, a user who opens the digital filtering and photo-sharing application through writing an “I” on the lock screen is not exposed to private pictures of the device owner.

Similarly, it may be possible to jot a quick note to a notebook application, such as MICROSOFT ONENOTE or EVERNOTE from Evernote Corp., invoking the notebook application through a user-defined gesture of a squiggly line or a character such as “O”. In response to the system recognizing that the user entered “O” via the lock screen, the corresponding task of open a quick note in the notebook application may be invoked and a screen can be surfaced to which a user can write (gesture or type) a quick note and then save.

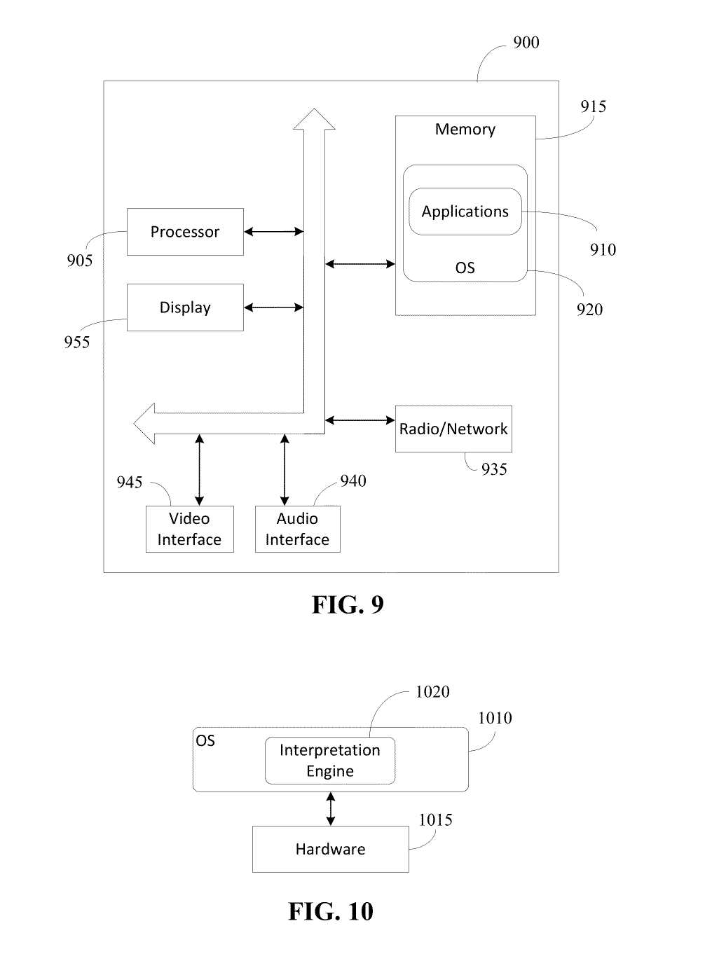

FIG. 9 shows a block diagram illustrating components of a computing device used in some embodiments. For example, system 900 can be used in implementing a mobile computing device such as tablet 530 or mobile phone 805. It should be understood that aspects of the system described herein are applicable to both mobile and traditional desktop computers, as well as server computers and other computer systems.

For example, system 900 includes a processor 905 that processes data according to instructions of one or more application programs 910, and/or operating system (OS) 920. The processor 905 may be, or is included in, a system-on-chip (SoC) along with one or more other components such network connectivity components, sensors, video display components.

The system 900 can include at least one input sensor. The input sensor can be a touch screen sensor, a microphone, a gyroscope, an accelerometer or the like.

An example of using a gyroscope or accelerometer can include user-defined shaking and orienting to invoke a task. For example, a user may flick a device up to send that they are running late to a meeting; flick sideways to indicate another user-defined command.

In some cases, a physical button may be selected as the user-defined input, where a home button may be pressed in a pattern to invoke the command.

In some cases, voice commands or sounds may be used to invoke an application from above the lock screen. The commands can be programed by the user in a similar manner that the gestures are defined.

As a non-limiting example, the system 900 includes a touch sensor that takes the capacitive touch from a finger and provides that value (and pixel location) to the operating system, which then performs processing to sense whether the values correspond to a gesture. Currently certain actions are hard coded, such as a swipe to indicate unlocking the device. Embodiments extend this functionality to enable user-defined gestures that are then associated with a certain task.

The one or more application programs 910 may be loaded into memory 915 and run on or in association with the operating system 920. Examples of application programs include phone dialer programs, e-mail programs, PIM programs, word processing programs, Internet browser programs, messaging programs, game programs, and the like. Other applications may be loaded into memory 915 and run on the device, including various client and server applications.

Examples of operating systems include SYMBIAN OS from Symbian Ltd., WINDOWS PHONE OS from Microsoft Corporation, WINDOWS from Microsoft Corporation, PALM WEBOS from Hewlett-Packard Company, BLACKBERRY OS from Research In Motion Limited, IOS from Apple Inc., and ANDROID OS from Google Inc. Other operating systems are contemplated.

System 900 may also include a radio/network interface 935 that performs the function of transmitting and receiving radio frequency communications. The radio/network interface 935 facilitates wireless connectivity between system 900 and the “outside world,” via a communications carrier or service provider. Transmissions to and from the radio/network interface 935 are conducted under control of the operating system 920, which disseminates communications received by the radio/network interface 935 to application programs 910 and vice versa.

The radio/network interface 935 allows system 900 to communicate with other computing devices, including server computing devices and other client devices, over a network.

The network may be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways.

In various implementations, data/information stored via the system 900 may include data caches stored locally on the device or the data may be stored on any number of storage media that may be accessed by the device via the radio/network interface 935 or via a wired connection between the device and a separate computing device associated with the device.

An audio interface 940 can be used to provide audible signals to and receive audible signals from the user. For example, the audio interface 940 can be coupled to speaker to provide audible output and a microphone to receive audible input, such as to facilitate a telephone conversation. System 900 may further include video interface 945 that enables an operation of an optional camera (not shown) to record still images, video stream, and the like. The video interface may also be used to capture certain images for input as part of a natural user interface (NUI).

Visual output can be provided via a display 955. The display 955 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form.

The display 955 may be a touchscreen display. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

In other embodiments, a touch pad may be incorporated on a surface of the computing device that does not include the display. For example, the computing device may have a touchscreen incorporated on top of the display and a touch pad on a surface opposite the display.

In some embodiments, the touchscreen is a single-touch touchscreen. In other embodiments, the touchscreen is a multi-touch touchscreen. In some embodiments, the touchscreen is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims.

In some embodiments, the touchscreen supports a tap gesture in which a user taps the touchscreen once on an item presented on the display. The tap gesture may be used for various reasons including, but not limited to, opening or launching whatever the user taps. In some embodiments, the touchscreen supports a double tap gesture in which a user taps the touchscreen twice on an item presented on the display. The double tap gesture may be used for various reasons including, but not limited to, zooming in or zooming out in stages, and selecting a word of text. In some embodiments, the touchscreen supports a tap and hold gesture in which a user taps the touchscreen and maintains contact for at least a pre-defined time. The tap and hold gesture may be used for various reasons including, but not limited to, opening a context-specific menu.

For embodiments using a swipe gesture, the touchscreen supports a swipe gesture in which a user places a finger on the touchscreen and maintains contact with the touchscreen while moving the finger linearly in a specified direction. A swipe gesture can be considered a specific pan gesture.

In some embodiments, the touchscreen can support a pan gesture in which a user places a finger on the touchscreen and maintains contact with the touchscreen while moving the finger on the touchscreen. The pan gesture may be used for various reasons including, but not limited to, moving through screens, images, or menus at a controlled rate. Multiple finger pan gestures are also contemplated. In some embodiments, the touchscreen supports a flick gesture in which a user swipes a finger in the direction the user wants the screen to move. The flick gesture may be used for various reasons including, but not limited to, scrolling horizontally or vertically through menus or pages. In some embodiments, the touchscreen supports a pinch and stretch gesture in which a user makes a pinching motion with two fingers (e.g., thumb and forefinger) on the touchscreen or moves the two fingers apart. The pinch and stretch gesture may be used for various reasons including, but not limited to, zooming gradually in or out of a website, map, or picture.

Although the above gestures have been described with reference to the use one or more fingers for performing the gestures other objects such as styluses may be used to interact with the touchscreen. As such, the above gestures should be understood as being illustrative and should not be construed as being limiting in any way.

To facilitate the implementation of user-defined gesture based shortcuts, the computing device implementing system 900 can include the illustrative architecture shown in FIG. 5.

Referring to FIG. 10, the operating system 925 of system 900 can include a device operating system (OS) 1010. The device OS 1010 manages user input functions, output functions, storage access functions, network communication functions, and other functions for the device. The device OS 1010 may be directly associated with the physical resources of the device or running as part of a virtual machine backed by underlying physical resources. According to many implementations, the device OS 1010 includes functionality for recognizing user gestures and other user input via the underlying hardware 1015 as well as supporting the user-defined shortcuts to access applications running on the device (and invoke custom tasks).

For the above the lock screen functionality, the operating system interpretation engine 1020 is used and incorporated with an input recognition component (e.g., 202 of FIG. 2). An interpretation engine 1020 of the OS 1010 listens (e.g., via interrupt, polling, and the like) for user input event messages. The user input event messages can indicate a swipe gesture, panning gesture, flicking gesture, dragging gesture, or other gesture on a touchscreen of the device, a tap on the touch screen, keystroke input, or other user input (e.g., voice commands, directional buttons, trackball input). The interpretation engine 1020 translates the user input event messages into messages understandable by, for example, the input recognition component (e.g., 202 of FIG. 2) to recognize a user-defined shortcut.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the media by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Communication media, particularly carrier waves and other propagating signals that may contain data usable by a computer system, are not included in “computer-readable storage media.”

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” do not consist of carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. One or more computer readable storage media having program instructions stored thereon for facilitating user-defined shortcuts for actions above a lock screen that, when executed by a computing device, directs the computing device to at least:
monitor user interactions made with respect to a user interface in a locked state for at least one interaction associated with at least one feature of one application of a plurality of applications otherwise accessible through the user interface when in an unlocked state; and
in response to an occurrence of the one interaction associated with the one application, invoke the feature of the one application while maintaining the user interface in the locked state.

2. The media of claim 1, wherein the user interface in the locked state is configured as a lock screen having a designated region to receive the at least one interaction.

3. The media of claim 2, wherein the at least one interaction comprises a gesture.

4. The media of claim 2, wherein the at least one interaction is a touch-based gesture comprising at least one of a symbol, character, circle, and multi-touch.

5. The media of claim 2, wherein the lock screen further comprises an unlock region, wherein in response to receiving an input via the unlock region, the computing device is directed to transition to an unlocked state.

6. The media of claim 5, wherein the unlock region and the designated region overlap physically and temporally.

7. The media of claim 5, wherein the lock screen further comprises at least one icon shortcut corresponding to a specific application accessible while in the locked state.

8. The media of claim 1, wherein the instructions direct the computing device to further:
determine available features of the plurality of applications for locked state operation; and
in response to receiving the one interaction through a settings user interface, map at least the one feature of the one application with a user-defined shortcut comprising the one interaction associated with the one application;

9. The media of claim 8, wherein the available features are determined by calling each of the plurality of applications to request if a locked state operation is available.

10. A computing device comprising:
a processor coupled to a memory, the processor configured to execute the following computer-executable components stored in the memory:
a lock screen having a first region designated to receive a user-defined gesture and a second region designated to receive an application-defined gesture; and
an input recognition component configured to recognize the user-defined gesture, determine a corresponding selected application; and invoke the selected application to deploy functionality to execute a task all while a device is in a locked state.

11. The device of claim 10, wherein the application-defined gesture is a swipe to unlock.

12. The device of claim 11, wherein the first region and the second region overlap physically and temporally.

13. The device of claim 10, wherein the user-defined gesture comprises at least one of a symbol, character, circle, and multi-touch.

14. The device of claim 10, further comprising a shortcut database stored in the memory, wherein the input recognition component accesses the shortcut database for recognizing the user-defined gesture.

15. The device according to claim 14, further comprising a settings component configured to: receive a request to configure a shortcut; determine available applications having locked state functionality, the available applications including the selected application; receive the user-defined gesture; map the user-defined gesture to the selected application; and store said map in the shortcut database, all while in an unlocked state.

16. The device of claim 10, wherein the lock screen further comprises a third region for rendering at least one icon shortcut corresponding to a specific application accessible while in the locked state.

17. A lock screen user interface configured to receive gestural input on a designated region; in response to receiving a gesture corresponding to a recognized user-defined shortcut, invoking an application task to which the user-defined shortcut is mapped while; and surfacing content from the application task while remaining in a locked state.

18. The lock screen user interface of claim 17, further comprising an unlock region configured to receive input to transition to an unlocked state.

19. The lock screen user interface of claim 17, wherein the unlock region and the designated region overlap physically and temporally.

20. The lock screen user interface of claim 17, further comprising at least one icon shortcut corresponding to a specific application, wherein, in response to receiving a selected one of the at least one icon shortcut, deploying the specific application while remaining in the locked state.
